(19) United States
(12) Patent Application Publication
(10) Pub. No.: US 2009/0132396 A1
(43) Pub. Date: May 21, 2009

(54) REVENUE CYCLE CHARGE CAPTURE SYSTEM AND METHOD

(76) Inventor: Jennifer Wexler, Canfield, OH (US)

Correspondence Address: BACON & THOMAS, PLLC, 625 SLATERS LANE, FOURTH FLOOR, ALEXANDRIA, VA, 22314-1176, US

(21) Appl. No.: 12/265,190

(22) Filed: Nov. 5, 2008

Related U.S. Application Data
(60) Provisional application No. 60/996,196, filed on Nov. 6, 2007.

(51) Int. Cl. G06Q 10/00

(52) U.S. Cl. 705/30

(57) ABSTRACT

A method for identifying charge capture opportunities comprises steps of receiving and storing in a server computer at least one itemized bill and at least one final bill, comparing the final bill to the itemized bill to identify line item discrepancies between the bills, comparing either or both bills to a Charge Description Master (CDM) to identify discrepancies between line items of the bill and correct charges defined in CDM, and evaluating final bill according to a set of rules to identify potential missing charges associated with billed charges. Additionally or alternatively, itemized charges can be evaluated according to the rules to identify potential missing charges. Potential missing charges are displayed to a user as revenue opportunities for correction of the bill or other remedial action.

### FIELD OF THE INVENTION

The present invention relates to medical patient billing, and more particularly to a revenue cycle charge capture system and method.

### BACKGROUND

The health care industry is consistently evolving and many organizations are challenged to keep pace, presenting obstacles to providers that prevent the establishment of an effective revenue cycle.

As a growing urgency to increase bottom line revenues is forcing providers to stay competitive within the market by leveraging new, emerging technologies, there is increasing political and legislative focus on consumer-driven health care and transparent billing practices industry-wide.

Clinical specialization and provision of diverse outpatient services has contributed to reliance of many hospitals to support charge capture activities through disparate clinical and billing systems. Additionally, charge capture is typically handled by clinical staff that may like be unfamiliar with payer charge capture, coding, billing and ultimately reimbursement guidelines.

A clean claim often requires effective interdepartmental coordination and communication, which is often inefficient and undervalued.

It is estimated that 80-90% of all patient bills contain errors, which are likely to lead to significant missing revenue.

Outpatient hospital and doctors visits have surged by 20% in the past five years and is only continuing to grow (1.2 billion visits in 2005 alone). Conversely, the number of clinicians (and hospitals) providing these services have not grown with the same vigor and in many cases has declined.

Ineffective charge capture management can result in significant missing revenue in the outpatient setting.

Comprehensive and accurate charge capture and reimbursement is typically dependent on effective interaction between various areas: clinical departments, Health Information Management, IT, Business Office, Finance, etc.

Disparate information systems (sometimes managed across multiple departments) must be able to effectively communicate and interact with one another.

Charges are reflected in line items in an itemized bill, or pre-bill statement. Items or services rendered to the patient should be charged (indicated on the itemized bill or pre-bill) and should appear as billed items on the final bill, or patient bill.

Generally, a hospital, clinic, or other facility maintains standard service charge information for billing in the form of a Charge Description Master (CDM) file. A CDM file contains charge information for all of the services, supplies and pharmaceuticals that the facility delivers, and is the principal source of data describing the services, supplies and pharmaceuticals to a third party payer or patient.

Accordingly, the CDM is the primary vehicle for correct coding, accurate billing, and systems integration.

A typical CDM is shown in FIG. (1), having several fields for each line entry. A department number field 101 is typically four to five digits in length and may or may not be the same as the department GL (general ledger). Regardless, this number should somehow link to account for department costs.

This number may also be provided as a leading or ending portion of some charge codes for some facilities, making the task of identifying costs back to individual departments easier. In some cases, services may be “shared” between departments, making it difficult to assign a service to a department. In these cases, a charge entry area, or location, may be associated with the service. This location ID us used to map the service back to the department. In addition to requesting the hospital CDM, it is important to request the table associations.

An item number 103 is an identifier (ID) assigned to a particular service in the CDM. For some facilities, the combination of department and item number constitutes the complete “charge code.” This field is typically 5 to 6 digits in length, but can be less or more, depending on the facility.

A service description field 105 contains a description of the service or supply contained in the CDM entry. Generally, hospitals and outpatient clinics have a methodology by which descriptions are described and assigned.

At least one CPT/HCPCS field 107 is provided, containing a CPT/HCPCS code associated with the service or supply described in the CDM entry. Plural fields may be provided, such as a primary or default field, and an override field that may contain a different CPT/HCPCS code such as for cases wherein a particular payer (Medicare, an insurance payer, etc.) requires a different code.

CPT/HCPCS are standardized billing codes, typically used in any health care provider setting (hospital, clinic, professional services). CPT stands for Current Procedural Terminology and HCPCS stands for Health Care Common Procedure Coding System).

Level I of the HCPCS is comprised of Current Procedural Terminology (CPT-4), a numeric coding system maintained by the American Medical Association (AMA). The CPT-4 is a uniform coding system consisting of descriptive terms and identifying codes that are used primarily to identify medical services and procedures furnished by physicians and other health care professionals.

These health care professionals use the CPT-4 to identify services and procedures for which they bill public or private health insurance programs.

CPT codes are always five digits in length and could range from 10000-99999, except in the case of new technologies, which may be assigned a numeric-alpha number (i.e. 0008T).

Level II of the HCPCS is a standardized coding system that is used primarily to identify products, supplies, and services not included in the CPT-4 codes, such as ambulance services and durable medical equipment, prosthetics, orthotics, supplies, and pharmaceuticals (DMEPOS) when used outside a physician's office.

Because Medicare and other insurers cover a variety of services, supplies, and equipment that are not identified by CPT-4 codes, the level II HCPCS codes were established for submitting claims for these items. HCPCS codes are alpha-numeric and are also five digits in nature.

The AMA (American Medical Association) oversees the assignment and utilization of Level I (CPT) codes, while the AHA (American Hospital Association) and CMS (Centers for Medicare and Medicaid Services) oversee Level II, HCPCS code assignment and administration.

The CDM entry may also include revenue code fields 109. A revenue code typically indicates what type or where the service was provided. Revenue codes were developed by NUBC (National Uniform Billing Committee) and are an integral part of the patient claim. Like CPT/HCPCS codes, revenue codes may be provided with default and override entries.

Additionally, each CDM entry includes a price that the facility charges for the service or supply.

Thus, for services and supplies provided during a patient encounter, itemized charges are entered on an itemized bill based on the information derived from the CDM. Once a patient bill is to be finalized, itemized charges are generally mapped into a final patient bill.

A typical patient bill 200 in the form of a standard UB-04 form, used in a hospital or clinical setting, is shown in FIG. 2.

The patient bill 200 includes patient information 202, as well as line entries 204 for each charged service, supply, or pharmaceutical. The line entries 204 include details of the charge, such as a revenue code 206, description 208 of the item charged, a billing or charge code such as a CPT/HCPCS code 210, service date 212, units charged 214, and total charges 216.

An itemized bill includes information similar to the patient bill, but comprises charges for patient services and supplies prior to consolidation (roll-up) of charges on the final bill, according to the type of service or supply. Charge information for each item charged in the itemized bill may be taken from the CDM, according to the item description, a CPT/HCPCS charge code, revenue code, item number, or other information contained in the CDM.

Typically, services or supplies with no CPT/HCPCS association undergo a systematic roll-up, where charges and units are combined according to like revenue codes.

In some cases, systematic roll-up of the revenue codes, quantities, and prices may be faulty, resulting in differences between the itemized bill and the final bill.

More typically, one reason why an itemized bill does not resemble its corresponding final bill is because of system disconnects between the clinical and billing system, an editing software (typically referred to as a “scrubber”) removes some charges according to predetermined edits. If scrubber edits are not properly maintained, it is possible that services are removed from the bill when they should not have been removed.

In other cases, differences between the itemized bill result from bill manipulation, such as omission or modification of charges found on the itemized bill .

A typical mapping of itemized bill information to final bill information is shown in FIG. 3. It can be seen that line items having a unique CPT/HCPCS code 210 appear with a one-to-one relationship between the itemized 300 and final 200 bills, while line items having no CPT/HCPCS code are combined according to their common revenue code 206.

In practice in a hospital or clinical setting, a patient final bill is typically a standardized form such as a UB-92 or UB-04 form. Additionally, with the prevalence of electronic claim submission, a final bill may correspond to an electronic format such as the 838i electronic format.

### SUMMARY

The present invention provides a revenue cycle charge capture system and method for identifying charge capture opportunities. According to one aspect of the method, charge capture opportunities may be identified by a comparison between an itemized bill and a final bill for a patient encounter. By performing such a comparison, errors or discrepancies in either or both of the itemized bill and the final invoice may be identified, leading to the recognition of potential charge capture opportunities.

According to another aspect of the method, charges found on both the itemized and final bills are verified by comparison of the amounts charged for services and supplies against a Charge Description Master (CDM) which defines the correct charges for the facility.

According to yet another aspect of the method, charges that should be, but have not been, billed are identified by analysis of either of the itemized bill or the final bill. This analysis employs a set of associative rules, whereby services, supplies or pharmaceuticals that would be expected to be found on a bill, given the presence on the bill of a service, supply or pharmaceutical that is known or expected to be associated with other services, supplies or pharmaceuticals, can be identified.

For example, a charge for a blood transfusion service should be accompanied by a charge for a blood product, since a blood product is required to perform the transfusion. Accordingly, if a charge for a blood transfusion service is found on a bill, but a charge for a blood product is missing, a revenue opportunity may be identified indicating that the final bill may require revision to include the blood product.

For any given service or supply, a rule may be defined as a list of one or more other services or supplies that would be expected to be charged together. Rules may also be defined to identify services that were billed together but should not be according to federal regulations. Accordingly, not only are missing charges or revenue found, but also non-compliant charges.

The system is implemented generally by providing a computer system with a computer program to execute steps of the method. According to one aspect of the system, the computer system is a server computer which is accessible by, and configured to communicate with, one or more other computer systems via a network such as the Internet. The other computer systems may include user computers, database servers, administrative computers, and the like.

These and other features, aspects, and advantages of the present invention will become better understood with regard to the following description, appended claims, and accompanying drawings.

### BRIEF DESCRIPTION OF THE DRAWINGS

FIG. 1 illustrates one example of a hospital Charge Description Master (CDM).

FIG. 2 illustrates a standard patient billing form.

FIG. 3 illustrates a mapping of itemized charges (an itemized bill) to a final bill.

FIG. 4 is a flow chart of a method for identifying charge capture opportunities, or missing or non-compliant revenue, among itemized charge information and a patient final bill for a patient encounter.

FIG. 5 is a user display screen image providing a display of a list of patient encounters along with control objects for selection of a patient encounter.

FIG. 6 is a flow chart of a method for comparing itemized charges (an itemized bill) to a final bill.

FIG. 7 is a screen shot of a user interface display, according to one embodiment of the present invention.

FIG. 8 is a user display screen image providing a display of compared itemized and final charges.

FIG. 9 is a user display screen image providing a display of a patient final bill and identified charge opportunities, along with control objects to select final bill line items for editing.

FIG. 10 is a user display screen image similar to that shown in FIG. 15, except that itemized charges are shown along with control objects to select the itemized charges for editing.

FIG. 11 is one embodiment of an association mapping table according to the present invention.

FIG. 12 is a block diagram of one embodiment of an association mapping table entry according to the present invention.

FIG. 13 is another embodiment of an association mapping table according to the present invention.

FIG. 14 is a user display screen image showing an association mapping table according to the present invention.

FIG. 15 is a flow chart of a method for performing a rule-based, associative analysis of a bill.

FIG. 16 is a user display screen image providing a display of itemized charges and identified charge opportunities.

FIG. 17 is a user display screen image providing entry of search criteria for searching itemized or final bills.

FIG. 18 is a block diagram of an embodiment of a system implementing the revenue cycle charge capture method for identifying charge capture opportunities.

FIG. 19 is a block diagram of a computer device.

FIG. 20 is a flow chart of a server computer implementation of a method for identifying charge capture opportunities, or missing or noncompliant revenue.

FIG. 21 is a diagrammatic representation of a CDM tracking and change monitoring feature of the present invention.

FIG. 22 is a partial user display screen image showing a display of CDM change data.

FIG. 23 is a partial user display screen image showing a dialog box for entry of CDM search criteria.

FIG. 24 is a partial user display screen image showing CDM change statistics.

FIG. 25 is a user display screen image showing a revenue trending profile.

FIG. 26 is a user display screen image showing a tabular representation of revenue trending data.

FIG. 27 is user display screen image showing an automatically generated email alert reporting a reported charge variance.

FIG. 28 is a user display screen image providing fur user login information entry.

FIG. 29 is a user display screen image showing an initial user screen and customizable report dashboard.

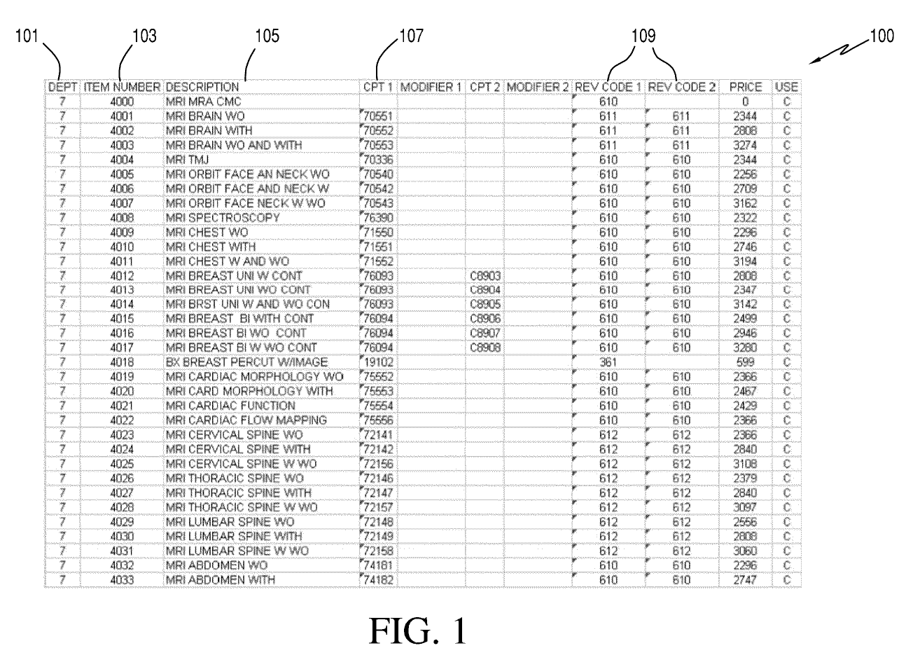

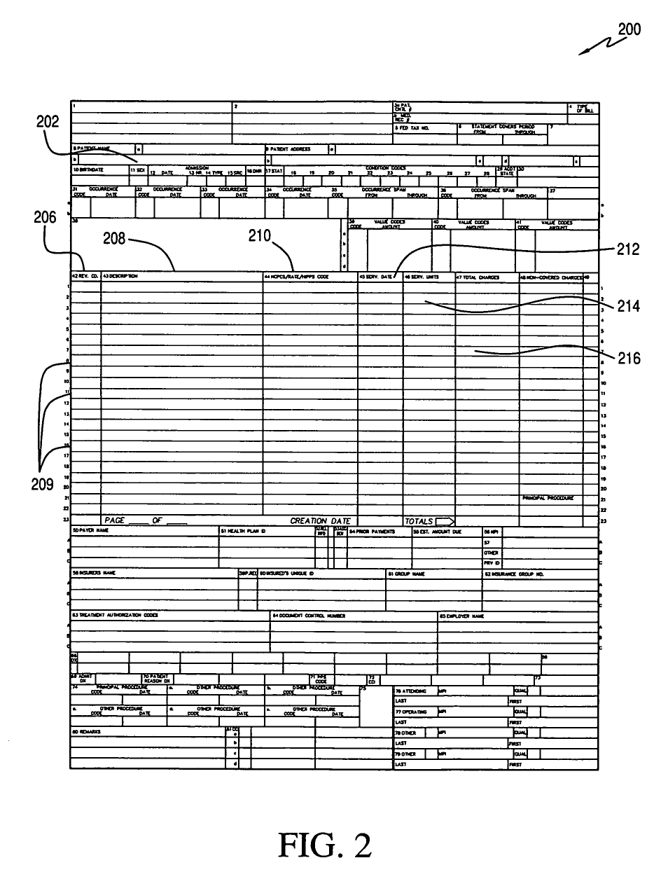

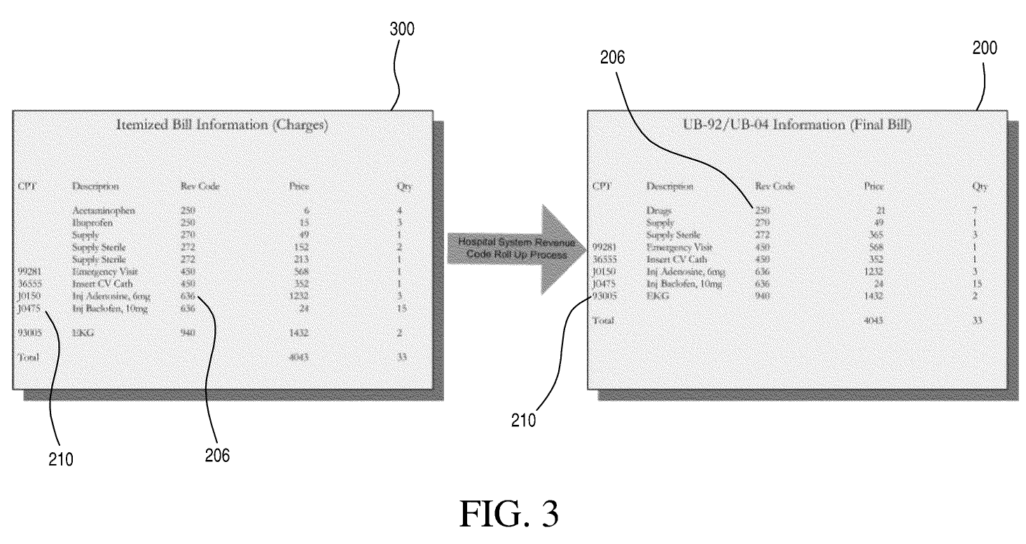

### DETAILED DESCRIPTION OF VARIOUS EMBODIMENTS

The present invention provides a revenue cycle charge capture system and method for identifying charge capture opportunities, or missing or non-compliant revenue.

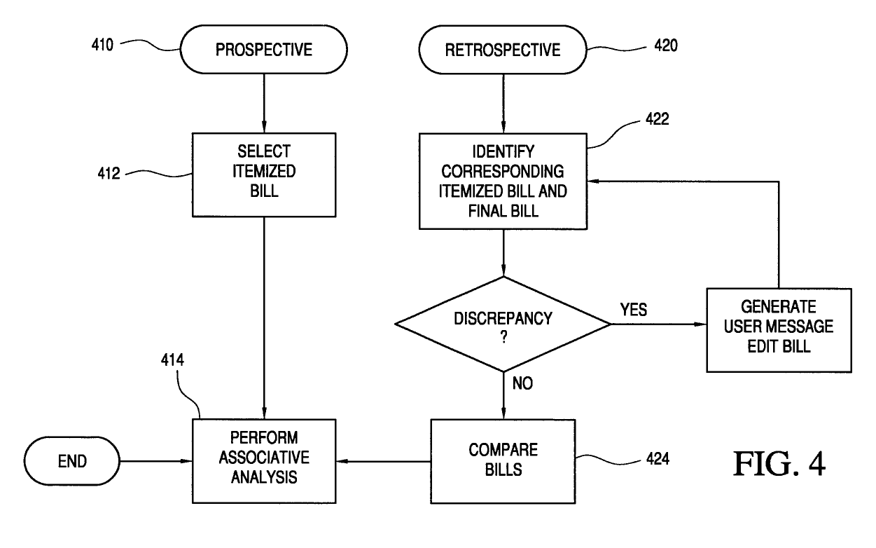

Referring to FIG. 4, patient bills are evaluated both prospectively (at 410), to identify missing revenue opportunities (missing or non-compliant revenue) before a patient bill is finalized (thus significantly reducing late charges and increasing bottom line revenues and cash flow), and retrospectively (at 420), to identify missing revenue opportunities after a patient bill is finalized (thus creating a “rebill” opportunity and increasing bottom line revenues).

For a prospective evaluation, an itemized bill for a patient encounter is selected (at 412) and analyzed according to a set of rules to identify potential missing charges associated with billed charges (at 414), prior to generation of the final bill.

For a retrospective evaluation, a final bill for a given patient encounter is compared to a corresponding itemized bill (at 424) to identify discrepancies between the itemized bill information and the final bill. In the retrospective evaluation, the final bill is analyzed according to a set of rules, similarly to the prospective analysis (at 414), to identify potential missing charges associated on the final bill.

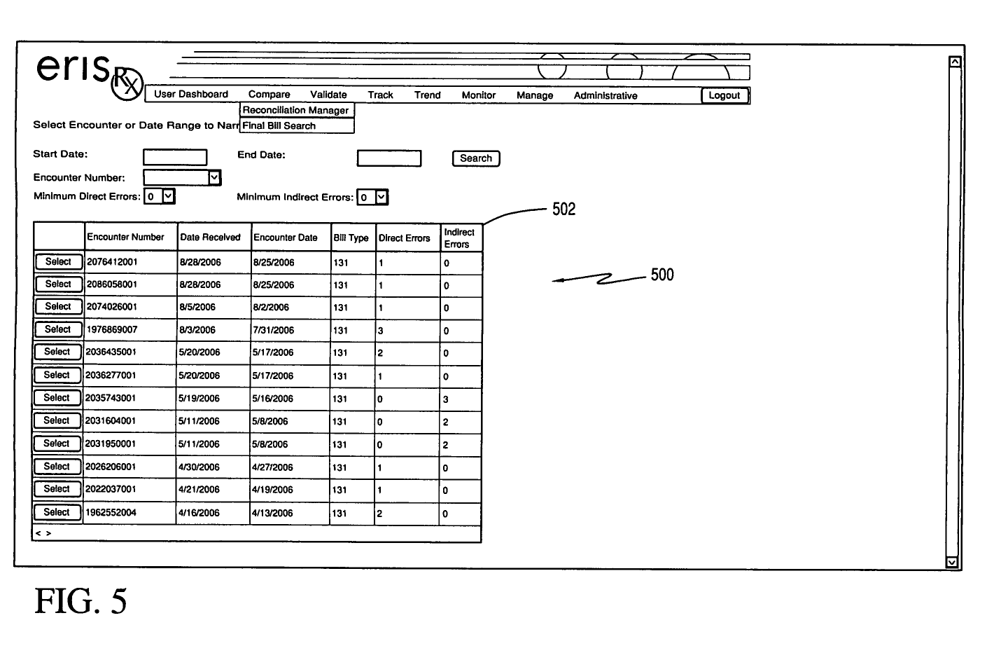

In conducting the retrospective analysis it is initially necessary to identify, for a single patient encounter, a single itemized bill and a single corresponding final bill (at 422). FIG. 5 shows a user display 500 providing a list of patient encounters 502 for selection.

It is possible that for a patient encounter there may be, for example, an itemized bill but no final bill, or vice versa. For the purpose of comparison of the final bill to the itemized bill, of course, both are needed. Thus, in the event that one is missing, an exception is reported to the user for correction.

Another possibility is the existence of multiple final bills for a single itemized bill. This may occur when a final bill has been submitted more than once, such as an initial claim submission followed by one or more subsequent submissions for the same patient encounter.

Once these discrepancies are identified and corrected, comparison between an itemized bill and its corresponding final bill can be conducted (at 424). After bill comparison, the final bill is audited according to a rules-based, associative analysis of final bill charges to identify further missing or incorrect charges on the final bill (at 414).

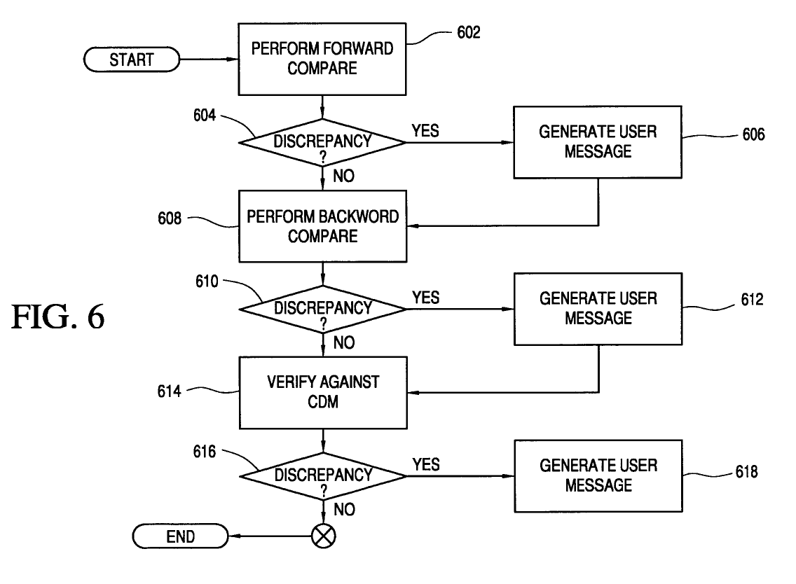

Referring to FIG. 6, forward and backward comparisons can be performed between the itemized bill and the final bill. In a forward comparison (step 602), line items on the itemized bill are matched to corresponding line items on the final bill to verify that the corresponding line item is found, and that the corresponding line item is correct.

In a backward comparison (step 608), line items on the final bill are matched to corresponding line items on the itemized bill. By performing both forward and backward comparisons, discrepancies between the bills can be found in both a case where items on the itemized bill are not reflected on the final bill, and where items on the final bill do not appear on the itemized bill.

Certain items on the itemized bill should appear with a one-to-one correspondence on the final bill. For example, each item on the itemized bill having a CPT or HCPCS code, a corresponding item should match a corresponding entry on the final bill.

on the other hand, certain items on the itemized bill are “rolled up” according to a category or type of the service or supply, and may have an n-to-one correspondence between the itemized bill and the final bill, wherein several line items on the itemized bill are combined or rolled up into a single line item on the final bill.

For the line items expected to have a one-to-one correspondence between the itemized and final bills, a comparison is made to ensure that each item on the itemized bill has a corresponding entry on the final bill (and vice versa), and that details of the line items (cost, number of units) match.

For line items that are rolled up from the itemized bill to a single line item on the final bill, plural line items on the itemized bill that belong to a same category or type of the service or supply are totaled (both charges and units) and the totals are compared to a line item of the final bill corresponding to the same category or type of service or supply.

Discrepancies between the itemized and final bills are identified in a user display so that appropriate action or correction can be taken. Access to the patient bill, whether itemized or final, is accomplished through assignment of roles and permissions at the user level so that user-specific patient bill validation workflow can be created. Discrepancies can be identified by highlighting line items on a displayed version of each patient bill.

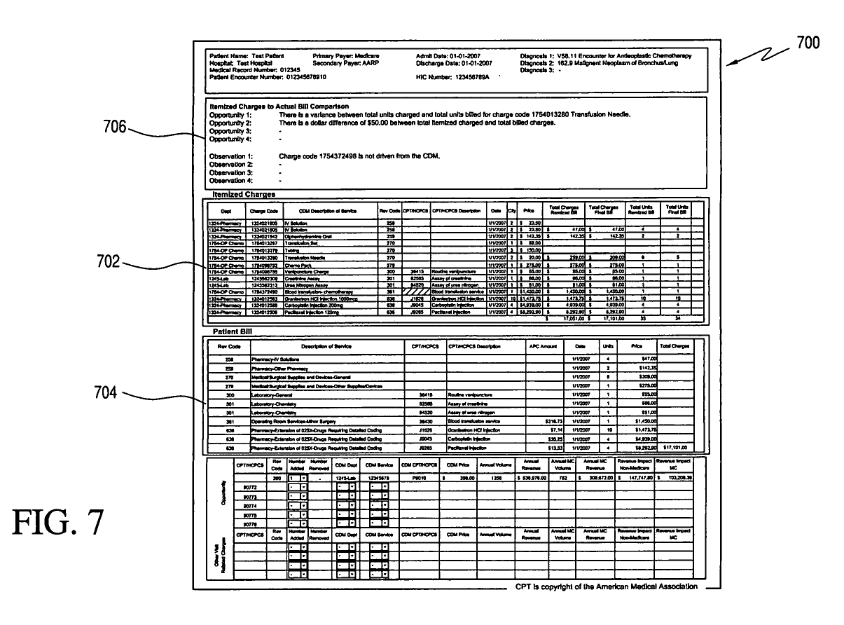

Additionally, a textual message can be presented to a user identifying the discrepancy as a charge opportunity. Referring to FIG. 7, a user display 700 is shown that includes an itemized display field 702, a final bill display field 704, and a discrepancy or charge opportunity display field 706 displaying discrepancies found by the comparison.

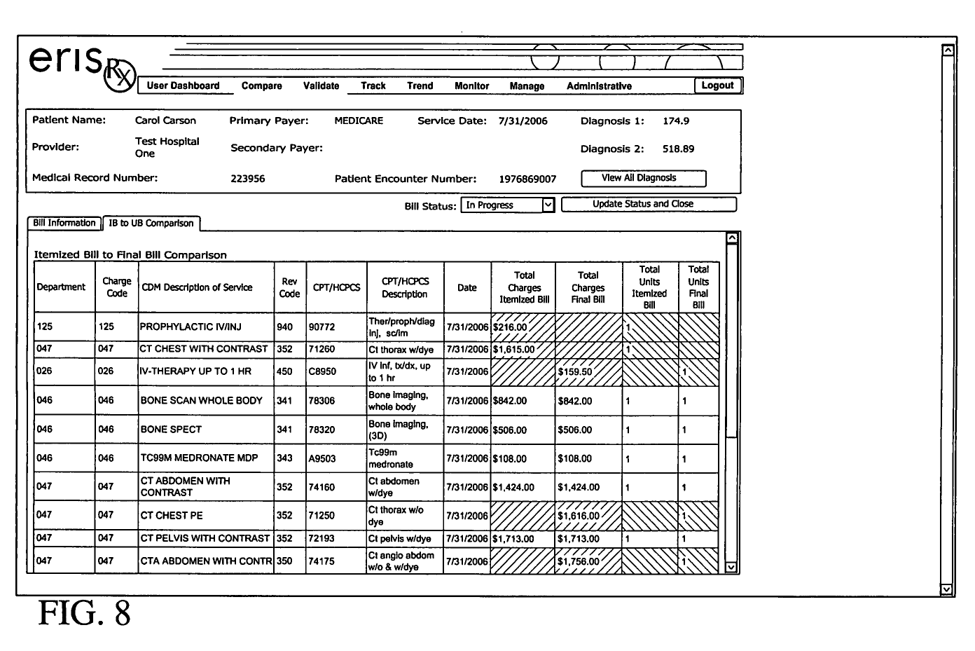

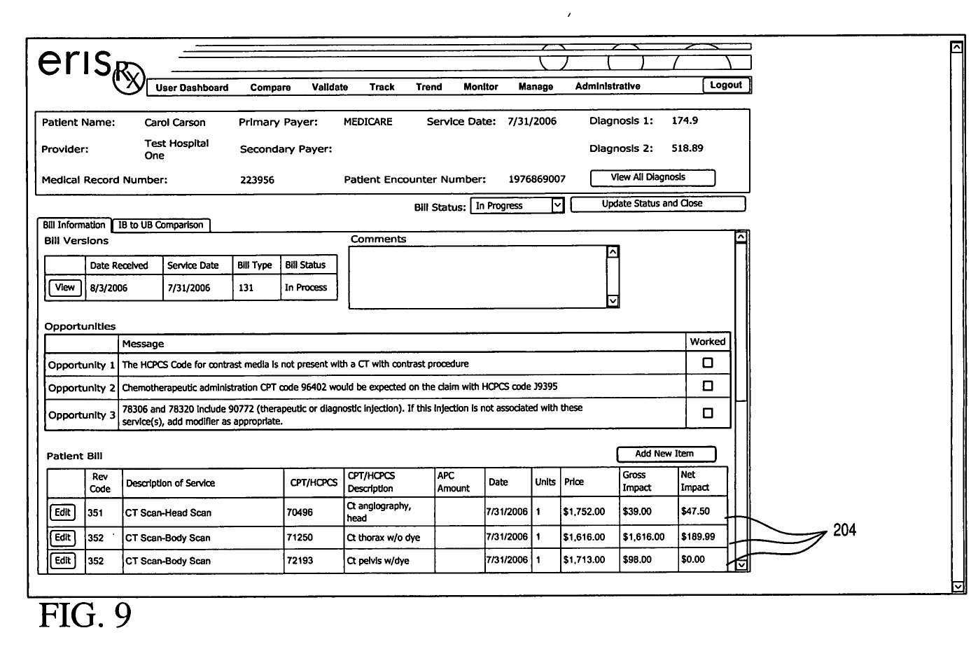

An alternative user display is shown in FIGS. 8 and 9. FIG. 8 shows a comparison of the itemized and final bill charge information, while FIG. 9 shows the final patient bill along with a summary of revenue opportunities found by the analysis. Line items 204 of the final bill are selectable for editing, so that discrepancies can be corrected by a user.

In addition to forward and backward comparisons to ensure consistency between the itemized and finalized bills, charges associated with the line items of both the itemized bill and the final bill can be verified against charges defined the CDM for the identified services or supplies.

For comparison against the CDM, a copy of the CDM data valid on the date of services identified on the patient bill is used. Accordingly, it is desirable to archive historic CDM data, and to update current CDM data periodically.

For both prospective and retrospective evaluation, a bill is analyzed according to a set of rules to identify potential missing charges associated with billed charges. For a prospective analysis, the rule-based analysis is performed on the itemized bill, prior to finalization of the patient bill. Conversely, for the retrospective analysis, the rule-based analysis is performed on the final bill subsequent to the comparison with the itemized bill as described above.

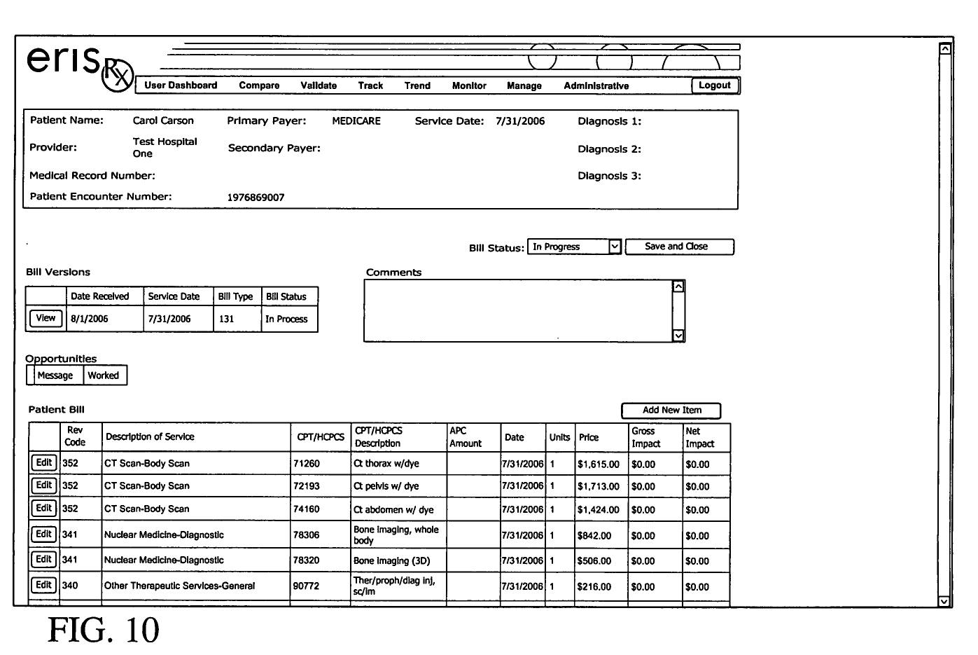

Referring to FIG. 10, a user display is shown that is similar to the user display of FIG. 7, but is directed to the prospective analysis. Instead of final bill entries, itemized charges are shown and are selectable for editing, so that discrepancies can be corrected by a user as designated by the roles and permissions assigned to the user. Thus, the itemized charges can be corrected prior to generation of the final patient bill.

The set of rules defines services, supplies or pharmaceuticals that are associated with one another, such that if a charge for a given service or supply is found on the final bill, a charge for one or more associated services, supplies or pharmaceuticals should also be found on the final bill.

For example, a charge for a blood transfusion service should be accompanied by a charge for a blood product, since a blood product is required to perform the transfusion. Accordingly, if a charge for a blood transfusion service is found on a bill, but a charge for a blood product is missing, a revenue opportunity may be identified indicating that the final bill may require revision to include the blood product.

Similarly, a needle biopsy procedure requiring guidance of a needle is likely to be associated with any one of several procedures for guiding or locating the needle. Accordingly, if a needle biopsy procedure charge is found on a bill, a charge for an associated procedure for guidance or location of the needle should be found as well.

Rules can be defined as absolute, where associated services or supplies must always be found together. Alternatively, rules may be defined according to a probability or likelihood of association. For example, a service or supply may be defined as being highly likely, moderately likely, or somewhat likely to be associated with another service or supply.

Each rule may be defined by a primary code, which is a code or identifier identifying the service or supply for which the rule is defined, and one or more associated codes which are codes or identifiers each identifying a service or supply associated with the primary code.

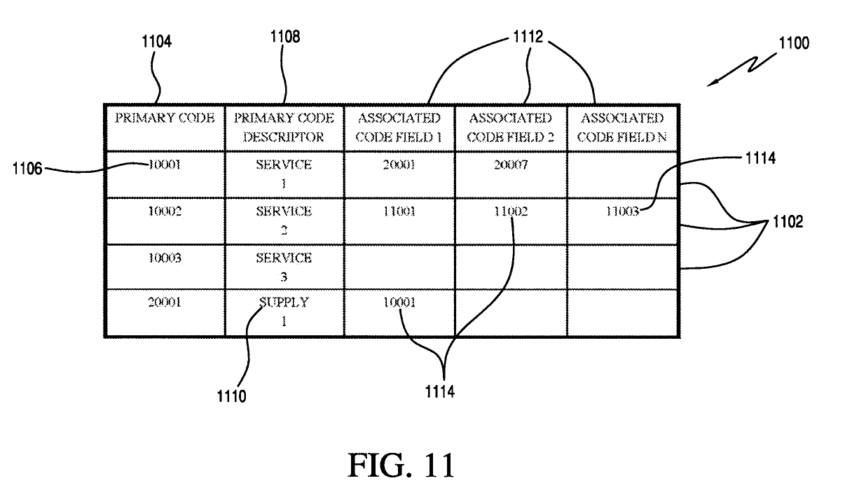

Referring to FIG. 11, rules can be defined in an association mapping table 1100. In one embodiment, the association mapping table 1100 has a row entry 1102 for each rule. Each row entry 1102 has a primary code field 1104 which contains a primary code 1106 identifying the service or supply for which the rule is defined. In the illustrated table, a CPT/HCPCS code is stored in the primary code field 1102. A primary code description field 1108 may be provided to include a description 1110 of the service or supply indicated by the primary code 1104.

Each row entry 1102 also includes a plurality of associated code fields 1112. One or more of the associated code fields 1112 for any row may contain an associated code 1114 identifying a service or supply associated with the row's primary code, or the associated code fields 1112 for a row may be left blank, indicating that there is no further service or supply associated with the primary code 1102.

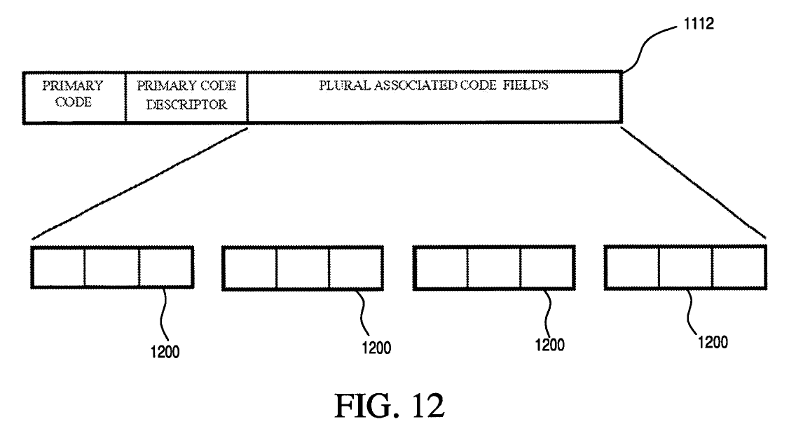

Referring to FIG. 12, the plurality of associated code fields 1112 may include plural associated code field sets 1200, wherein each associated code field set 1200 indicates a different category of associated codes. The different categories of associated codes may be defined according to different types of codes (such as CPT/HCPCS codes versus REVENUE codes) or according to different probability or likelihood of association with the primary code (such as highly likely, moderately likely, or somewhat likely to be associated with the primary code), or according to another criteria or a combination of criteria.

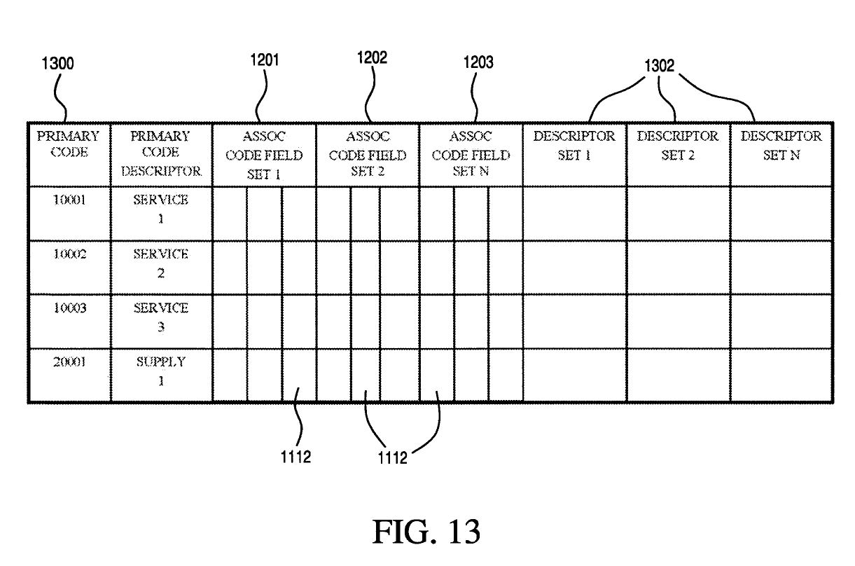

In the table 1300 seen in FIG. 13, a first associated code field set 1201 includes, for example, associated code fields for CPT/HCPCS codes having a direct association with the primary code, wherein a direct association indicates a likelihood or probability greater than a threshold value (such as greater than 80%) of an association with the primary code.

A second associated code field set 1202 includes, for example, associated code fields for CPT/HCPCS codes having an indirect association with the primary code, wherein an indirect association indicates a likelihood or probability less than a threshold value (such as less than 50%) of an association with the primary code.

Third and fourth associated code field sets 1203 (only a third is shown) include, for example, associated code fields for REVENUE codes having direct and indirect associations, respectively.

Opportunity description fields 1302 may be included to provide a description, discussion, or explanation of potential revenue opportunities indicated by the associations defined by entries in the associated code fields. The description fields 1303 may include, for example, text to be displayed when a revenue opportunity is identified according to a rule. A single description field 1302 may be defined in association with an entire rule 1102, or plural description fields 1302 associated with each associated code field 1112, or with each associated code field set 1200.

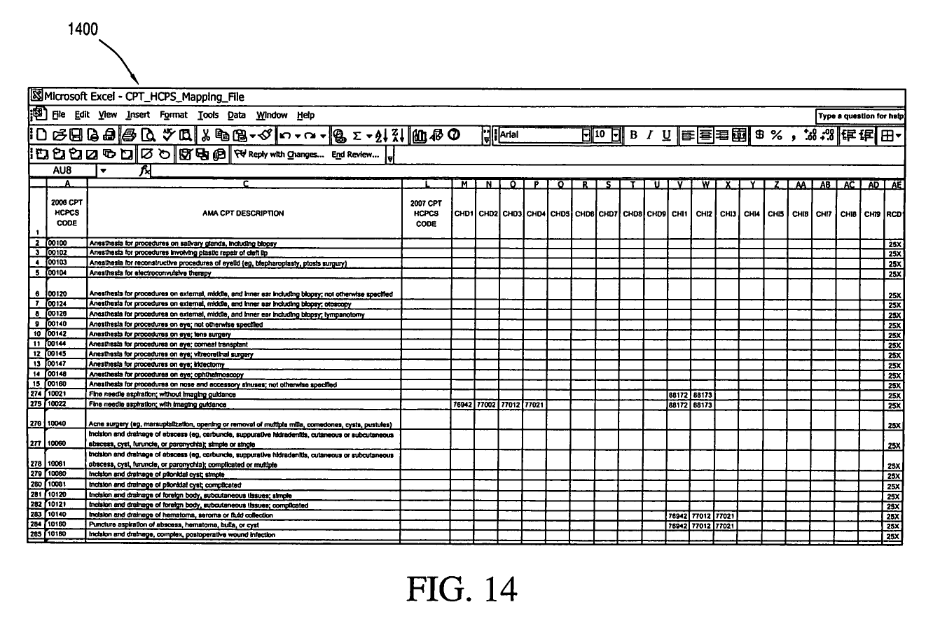

The association mapping table 1100 may be defined as a simple data table or array, in a spreadsheet format using a spreadsheet program, or in a database table structure for example using a database program. In an example shown in FIG. 14, an association mapping table 1400 is shown displayed by spreadsheet software, such as Microsoft Excel (trademark of Microsoft Corporation), which provides a convenient method to define, review, and edit the association mapping table 1400.

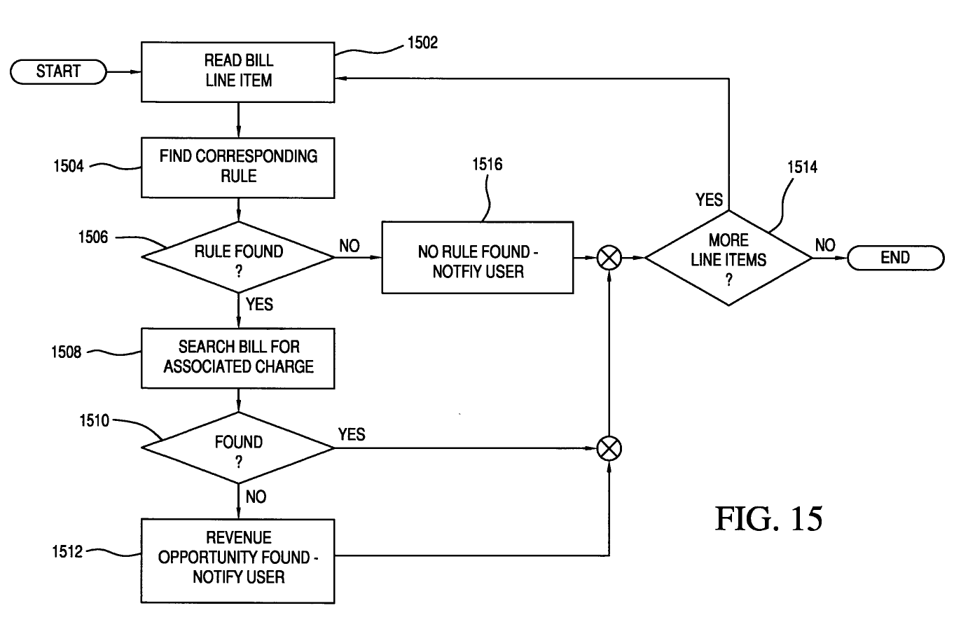

Referring to FIG. 15, a method for performing a rule-based analysis of a bill is described In evaluating a bill to identify potential missing charges associated with charges found on the bill, each line item of the bill may be evaluated by reading the line item (step 1502), and searching an association mapping table 1100 for a rule entry 1102 that may be applied to the line item (step 1504).

Such a rule entry is identified by finding a rule entry having a primary code 1106 that matches the charge code of the bill line item (wherein charge code refers to CPT/HCPCS, revenue code, units or any field in the mapping table that can be associated with a particular item contained on the patient bill).

If no matching rule entry 1102 is found, evaluation continues for the next bill line item, again searching the association mapping table 1100 for a matching rule entry 1102. Optionally, a message may be generated and displayed to a user indicating that no rule exists for the charge code (step 1516), in the event that it is desirable to create a new rule or otherwise update the association mapping table 1100.

If a rule entry 1102 matching the charge code of the bill line item is found, the evaluation continues for the bill line item. For each associated code field entry 1114 defined by the rule entry 1102, the bill is searched for a line entry that has a charge code matching the associated code field entry 1114 stored in the associated code field 1112 (step 1508). If none of the associated charge code field entries can be matched to a line item on the bill, the rule is considered to have “failed,” indicating that a charge opportunity exists.

When a rule has failed, text from one of the rule's description fields 1302 may be display to provide a user with information relating to the charge opportunity identified by the rule (step 1512).

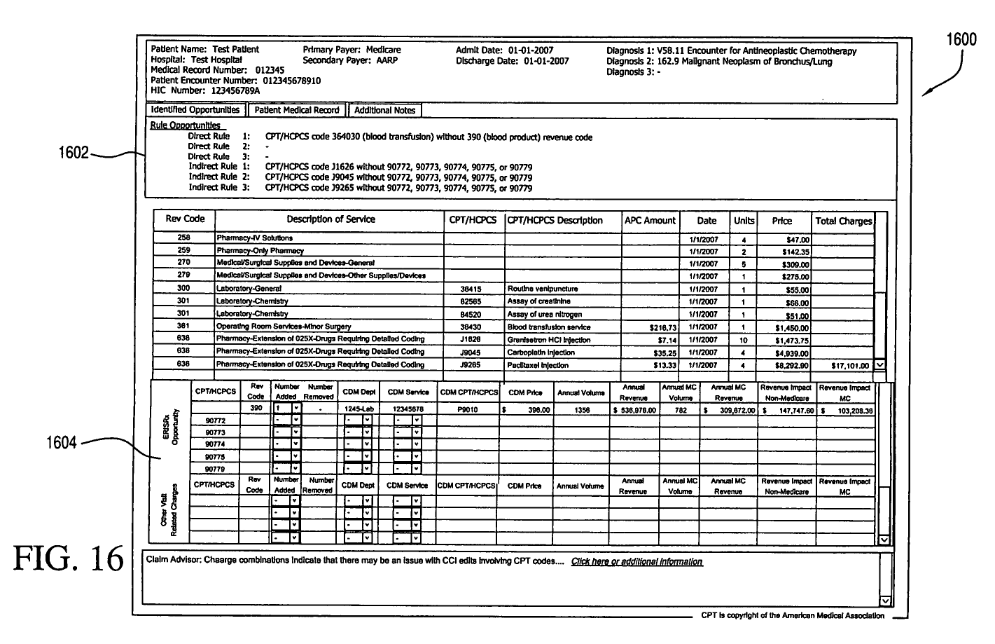

FIG. 16 shows one embodiment of a user display 1600 showing bill details, along with charge opportunities 1602 identified by the rule-based evaluation.

A working field 1604 is included in the user display 1600 wherein charges may be added or removed from the bill, and wherein added or removed charges may be tracked and trended for analysis and management of the overall charge capture process.

In addition, as each editable bill procedure, supply or pharmaceutical is associated through the charge description master (CDM) with a price, an estimated gross and net charge impact estimate is displayed after the user has modified, deleted, or added a particular bill item. This function is based on available Medicare and other governmental payer reimbursement rates as well as other payer contract matrices provided by the product user.

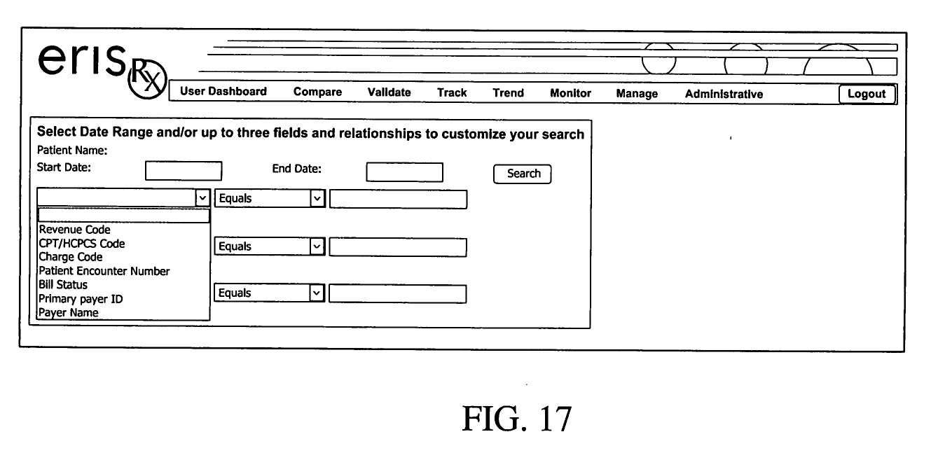

A search capability can be provided such that a user is able to search the patient itemized bills or final bills for specific bill elements using date criteria, specific fields in the CDM, or other bill element detail. A search dialog box (see FIG. 17) may be provided to allow entry of data to be searched, and selection of particular fields of the itemized bill or final bill to be searched.

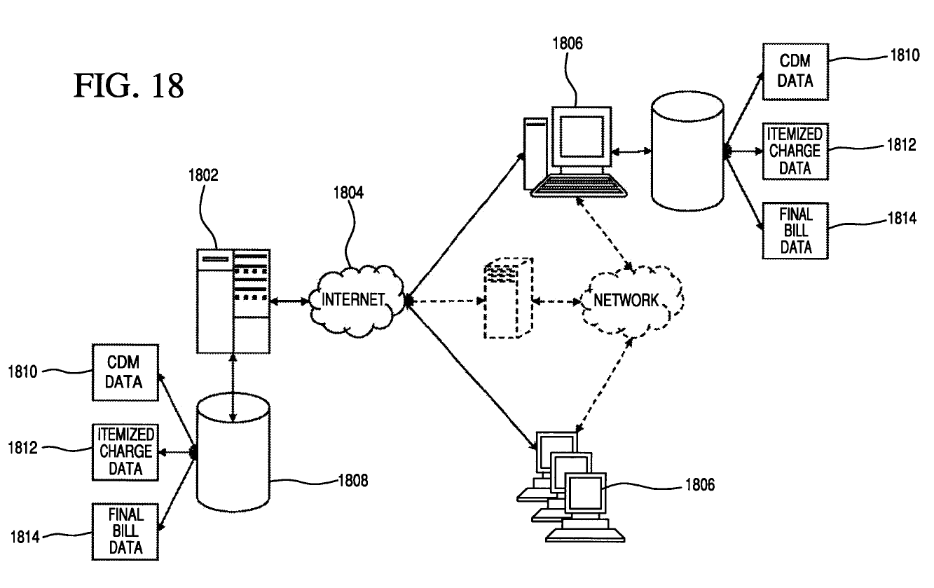

In a preferred embodiment, referring to FIG. 18, the system comprises a server computer 1802 connected to a network 1804 such as the Internet. The server computer 1802 is accessible by, and communicates with, one or more client computers 1806 via the Internet.

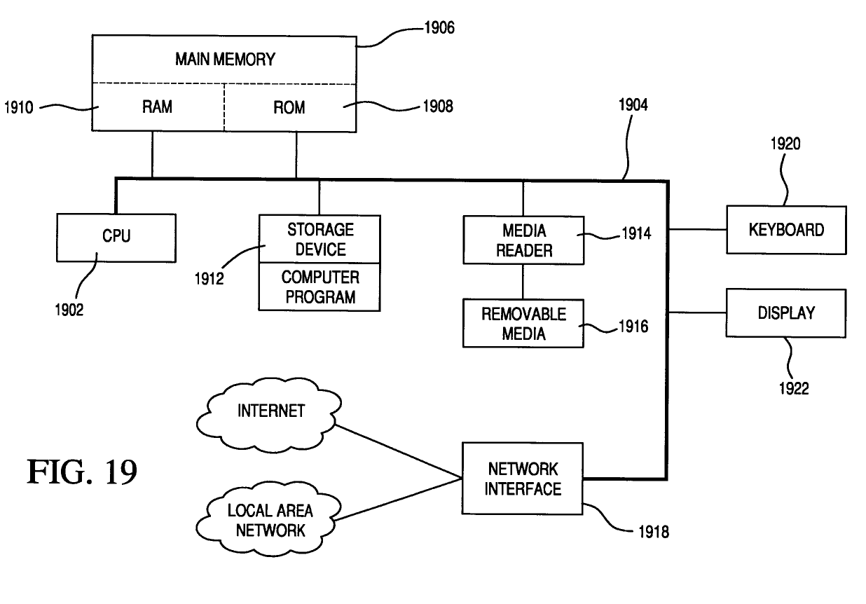

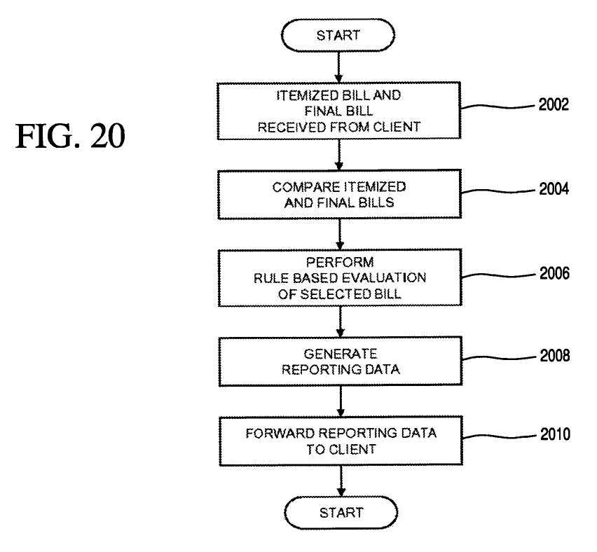

Such computer devices generally (but need not) correspond to a typical architecture as shown in FIG. 19. In such an architecture, a central processing unit (CPU) 1902 includes, or is connected by a bus 1904 to, an area of main memory 1906, comprising both read only memory (ROM) 1908, and random access memory (RAM) 1910, and a storage device 1912 such as a disk storage device having means for reading a coded set of program instructions on a computer readable medium which may be loaded into main memory 1906 and executed by the central processing unit (CPU) 1902. Additional storage devices may be provided, such as a media reader 1914 for reading a removable storage media 1916 such as a removable disk drive, CD-ROM drive, DVD drive, memory card, USB memory device, or the like.

The computer device includes at least one communication interface 1918 for communicating with another computer device or network device, such as a network interface, a modem, or any other device for establishing communications with another computer device or network device.

Typically, a keyboard 1920 and display 1922, or other input/output or user interface devices, are provided for user interaction.

Implemented by computer software in a server computer 1802, the method may include further steps of receiving data from, and forwarding data to, the client computers 1806.

In particular, final bills 1814 and their corresponding itemized bills 1812 are forwarded to the server computer 1802 (typically from a client's administrative database or other source), and stored in a database 1808 local to the server computer 1802 (step 2002). Also, it is desirable for the server computer 1802 to receive updated CDM data on a periodic basis.

The itemized charge data 1812, final bill data 1814, bills, and the CDM data 1810, may be requested by the server computer 1802 on a scheduled periodic basis, such as daily. Each of the final bills, itemized bills, and CDM may be received in the form of text files which can be parsed into appropriate formats (such as database tables or data structures) for processing.

The server computer 1802 performs comparison of the itemized and final bills (step 2004), and the rule-based analysis of selected bills (step 2006). The server computer 1802 generates reporting data based on discrepancies between compared bills and on missing charges identified by bill comparison or analysis (step 2006), and forwards the report data to a client computer for display (step 2008).

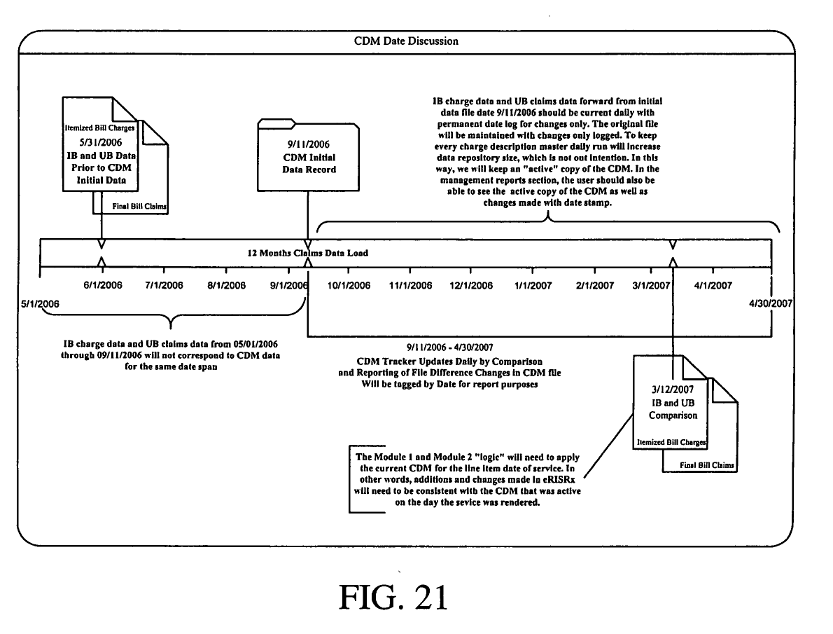

Referring to FIGS. 21-24, it is important that CDM data be updated, and that historic CDM data be archived, since correct evaluation of any patient bill against the CDM requires that the patient bill be evaluated against the CDM that was current as of the date of the patient bill (or individual items on the patient bill). Similarly any adjustments that are to be made to the patient bill must be made according to the CDM that was current as of the date of the patient bill.

Accordingly, it is desirable to be able to track CDM changes, and differences between successive versions of the CDM.

An initial CDM file, and corresponding user crosswalks (i.e. department crosswalk and other crosswalk tables if applicable) are collected from the user facility and stored. The date of the initial data record is stored in the system database. This is important for a reference mark in that claims imported for review prior to this date will not include CDM for dates of service prior to implementation date. Additionally, a creation date of each CDM line item may be included.

Every time a new CDM file is uploaded, any changes from the previous day are noted at the charge code level compared to the previous day. Because the CDM is a dynamic file in that changes are made often, any changes to data fields are tracked and logged by date.

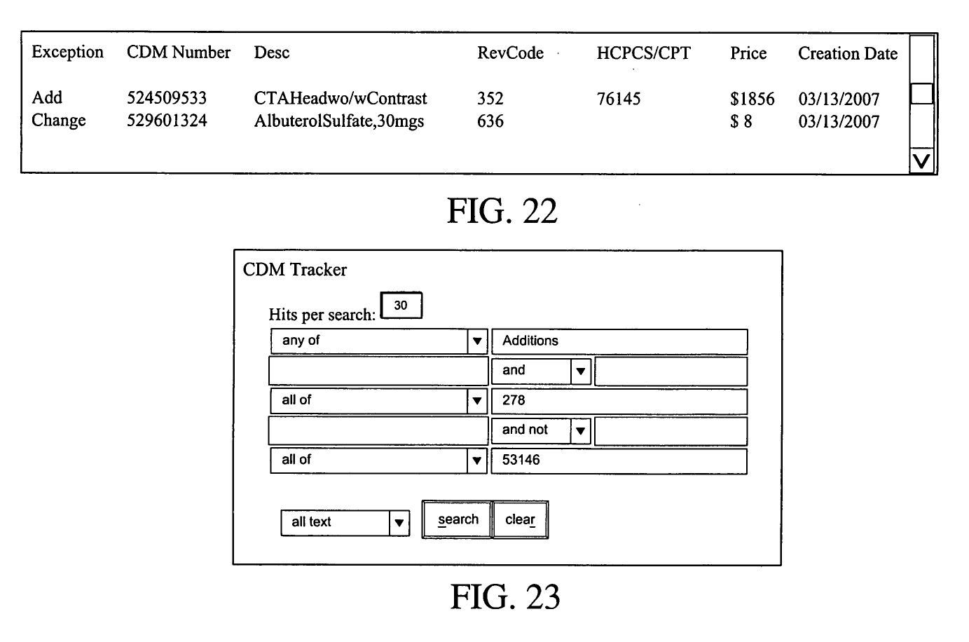

Referring to FIG. 22, changes made to the CDM file, since the initial file or since a given subsequent version, may be displayed for review by a user. Changed items are highlighted. Additionally, a previous value of any changed item can be displayed, such as by “clicking on” the item with a mouse or pointer device, by a “mouse over” operation, or the like.

In addition to display of changed items, the entire CDM may be displayed as of a selected dater again showing items that have changed since the initial file shown highlighted.

A search capability can be provided such that a user should is able to search the CDM for changes using date criteria as well as specific fields in the CDM. A search dialog box (see FIG. 23) may be provided to allow entry of data to be searched, and selection of particular fields of the CDM to be searched.

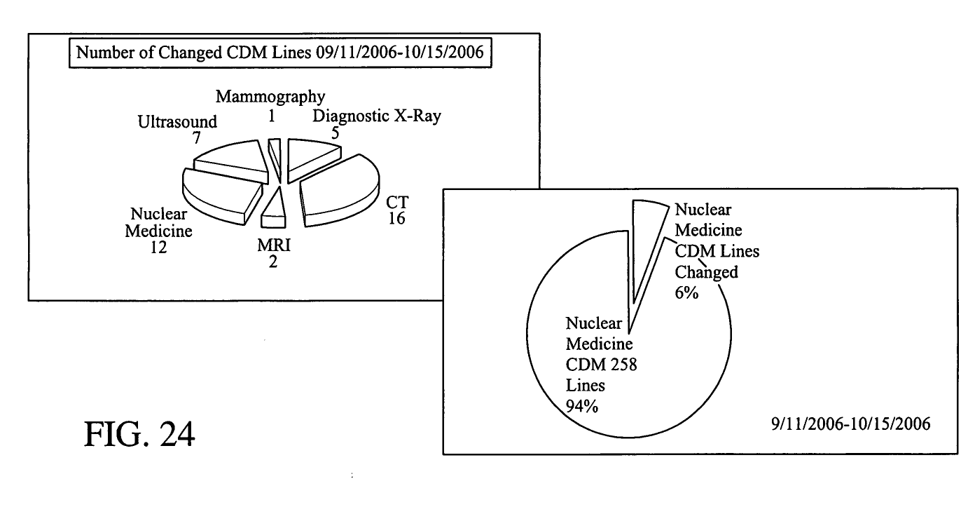

Referring to FIG. 24, CDM reports may be generated to indicate, for example indicating the number of CDM entries changed for each department, or the percentage of CDM entries that are changed in a given department.

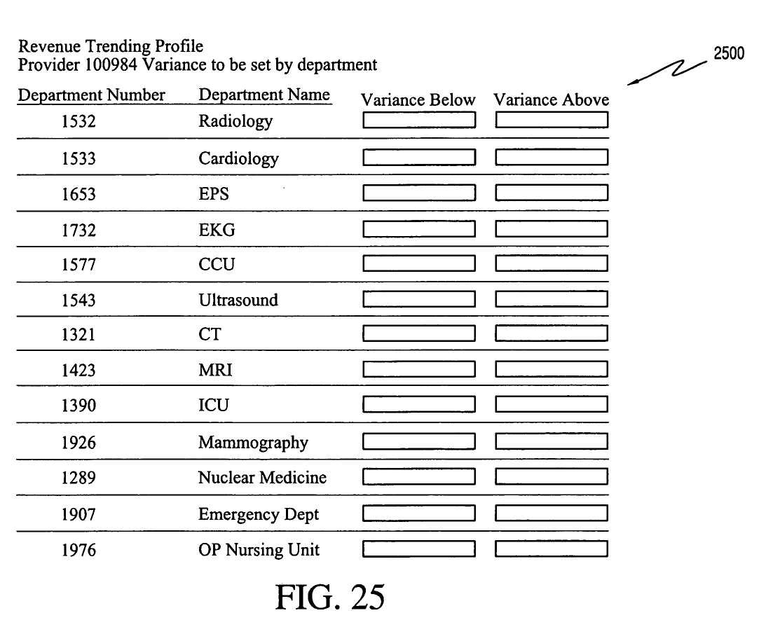

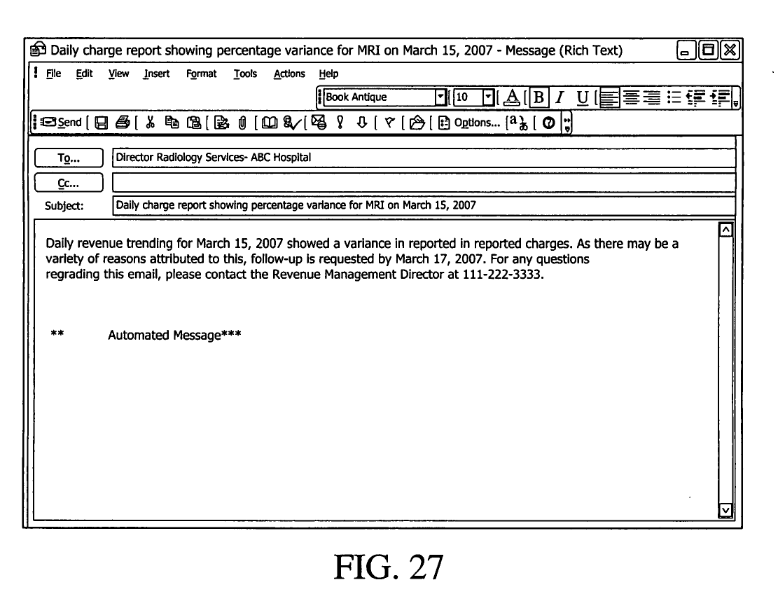

Referring to FIGS. 25-27, a daily revenue trending report 2500 can be generated from the billing data uploaded to the system, consisting of charges posted by department within a particular user facility on a daily basis.

These charges can be broken out by patient type categories, and by department or GL file map (if department number mapping is not available).

This report will be cumulative in that daily charges will be sent at batch by the user to the system, where a file can be accessed via FTP or other function. This report can be overwritten daily as long as the previous days report remains static (a master copy is saved with date log much like the CDM).

The daily file can be maintained in a table format, including fields such as: Hospital Id; Department Id; Department Description; Total Inpatient Charges by Department; Total Outpatient Charges by Department; Encounter number of account with late charges posted; Patient Last name, first name; Admit, discharge date of the encounter; Date the charge was posted; CDM number of charge posted; CDM description of charge posted; and Date the charge was posted.

Charges can be presented to a user in a calendar display for the current week. Previous month to date (by month) and year to date (rolled up by patient type—IP or OP) can be viewed by the user. This report will require no user manipulation, so it can be displayed as read-only.

The daily charges field can be associated with a variance benchmark. This benchmark will be determined by a user based on tracked data (or by experience), and will be client-specified. Accordingly, variance over or under expected charges can be identified.

From a System Administration standpoint, profiles can be set to drive the user-defined variances, as linkages between percentage revenue variance up or down in comparison with previous day and week revenues.

Once a variance has been established by a user, the system may generate a message to the user such as, for example, if an item falls outside of the established variance. For example, if outpatient daily charges fall outside the established 30% variance indicator for the ultrasound department, then an email will be sent to the Director of the department as an alert.

The user may provide an email address among user configuration data maintained by the system. The user may also define particular text for the body of the email.

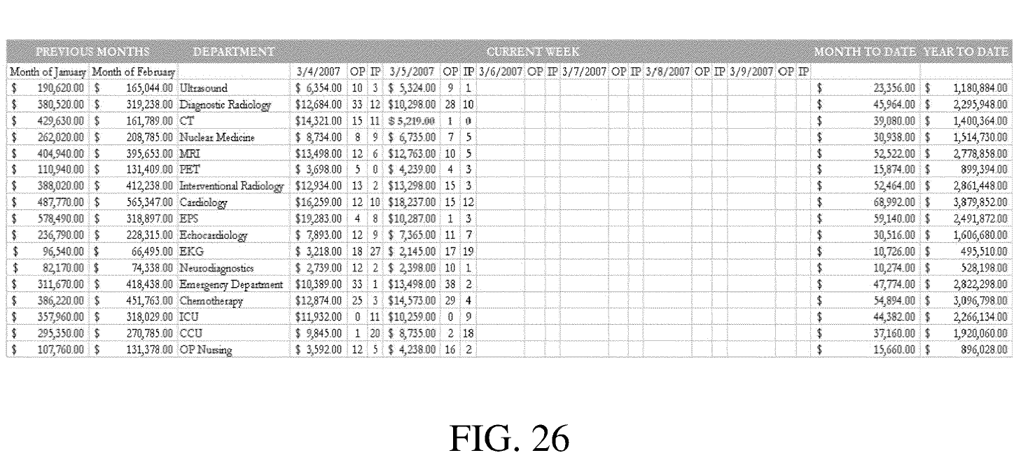

Revenue trending data may be displayed to a user, formatted in a table such as FIG. 26.

Like the daily revenue trending report, a late charge trending report can be generated. The late charge report shows, essentially, trending by day of charges posted, by department, to patient accounts that have been discharged.

In general, the definition of a late charge can vary from Provider to Provider. However, a typical “late charge” is 3 to 5 days post-patient discharge. These charges may be broken out by inpatient and outpatient by department or GL file map (if department number mapping is not available).

This report will be cumulative in that late charges will be sent by batch by the user to the system, where a file can be accessed via FTP. This report can be overwritten daily as long as the previous days report remains static (a master copy is saved with date log much like the CDM).

The daily file will include the following fields: Hospital Identifier; Department Identifier (Number or GL); Department Description; Total Inpatient Charges by Department; Total Outpatient Charges by Department; Encounter number of account with late charges posted; Patient first and last name; Admit and discharge dates of the encounter; CDM number of charge posted; CDM description of charge posted; and Date the charge was posted.

Like the daily charges field, the late charge report has both inpatient and outpatient data which can be associated with a variance benchmark. This benchmark will be determined by the user based on tracked data (or by experience) and will be user-specified. The purpose of this is to allow a means by which to identify variance over or under expected charges.

From a System Administration standpoint, profiles can be set to drive the user-defined variances.

As with the daily charges discussed above, once a variance has been established by a user, the system may generate a message to the user such as, for example, if an item falls outside of the established variance, such as by an automatically generated email message directed to a user-configured email address.

Several reports may be generated by the system. These may include, for example, a report of missing revenue and corrections by service, a report of missing revenue and corrections by user, and a report of failed claims per category, as well as other types of reports.

A report of missing revenue and corrections by service tracks the number of times a specific line item change was entered. A specific line item change will only is registered, for reporting purposes, when a user “completes” the patient encounter. While the system will keep track of all changes entered by all registered sub-users, this report will only allow a main user to view missing line item revenue for those CDM line items that fall within their accessibility clearance.

There are several types of changes that are reflected in this report. These include added patient charges (services that were provided to the patient but were never charged), service unit changes (services that were provided and charged to the patient but did not have appropriate service units applied to the patient bill), and deleted patient charges (services that were charged to the patient bill but were not supported by the clinical documentation).

A report of missing revenue and corrections by user the number, type of change, and specific changes completed by each registered user. A specific line item change will only register as a change, when the registered user “completes” the patient encounter.

A report of failed claims per category allows management (a managing or main user) to identify, monitor and ultimately correct the gaps in the current charge capture process.

The Failed Claims by Category report allows the main user to view the number of claims that have “failed” a particular algorithm (or all algorithms) to help prioritize work efforts of other users.

The main user may “search” on a particular CPT/HCPCS code to isolate all claims that have failed the algorithm for that code. Alternatively, the main user may elect to view “all fails” that fall under the user's accessibility clearance (according to the user's role or permissions).

The number of claims (and corresponding %) that have failed each requested algorithm are displayed, and if the user clicks on the number, a specific list of patients names, date of services, and encounter numbers that correspond to the “fail” are displayed. If the user clicks on a particular name, the specific claim and references as to why the claim failed are displayed.

The main user will have to specify a date range when searching for failed claims. Year-to-date (YTD) will be the “default.”

The user will have the ability to specify up to ten specific CPT/HCPCS codes to view at one time.

The user will be able to view past % fails and corresponding % corrected for each specified CPT/HCPCS code to help management over time identify persistent operational breakdowns. Not only will the user be able to view past % fails and % corrected for each referenced code, but also the corresponding “net identified revenue.”

Users access the server computer 1802 from user terminals 1806, to view data and documents generated by the server computer 1802 and to enter data or send data to the server computer 1802.

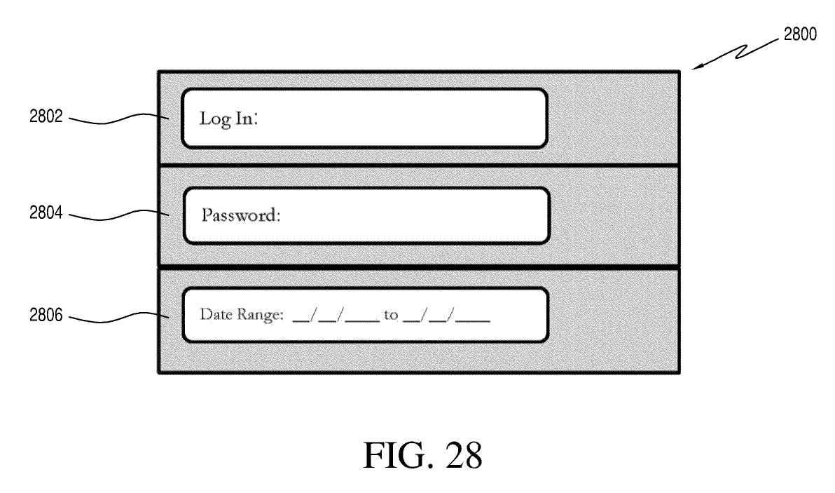

A user may be required to “log in” to use the system, such as by providing a username and password. Upon logging in, the user may also specify a date range, indicating the dates of patient encounters or bills of interest. A user login display 2800 is shown in FIG. 28, including a username field 2802, a password field 2804, and a date range entry field 2806.

Upon logging on, a user may be assigned both a user role and certain user permissions. Username and password should be associated with certain levels of access. These levels of access will drive a user's ability to visualize and/or manipulate data. The ability to assign access level should reside with a System Administrator and/or Super User at a user's site.

User roles may include, for example, functional roles such as an Administrator role, a Manager role, a Charge Analyst role, and the like.

A role can be unique to a certain department (clinical or otherwise) or can span multiple departments within a hospital or health system. Each role is assigned access to certain functions or has certain clearances within a function.

One example of a role is a “Charge Analyst”. The administrator would decide what clearances the “Charge Analyst” would have. For example, the Charge Analyst role may encompass having the ability to access all data associated with the prospective and retrospective analysis functions (view and manipulate claims data) only, but may not have access to some administrative functions.

Within a particular role (like the Charge Analyst role), a unique user may only have access to certain departments. Permissions are unique to a particular user, not necessarily a role. There may be multiple users assigned to the same role but each user will have unique permissions.

The permissions may be associated with clinical departments. For example, a unique user may be assigned to the role of a Charge Analyst (who has the ability to view and manipulate data), but according to the unique users assigned permissions, he or she may only be able to manipulate data for the Emergency Department.

Users may be limited to specific departments by facility designation (for example, driven by a user-specific GL department mapping tables). For example, System Administration and management might have access to view all departments and associated algorithms, while an Emergency Department Charge Analyst may be limited to view and modify only CDM or related information for the Emergency Department.

The algorithm “rules” mapping file may be tied to a department level, so identifying department will rely heavily on correct GL department mapping. GL department will be apparent in comparison of itemized bill to final bill as well as Charge Analyst itemized bill review functions. The algorithm “rules” mapping file may also be tied to a service line by revenue code to which user permissions and roles can be assigned.

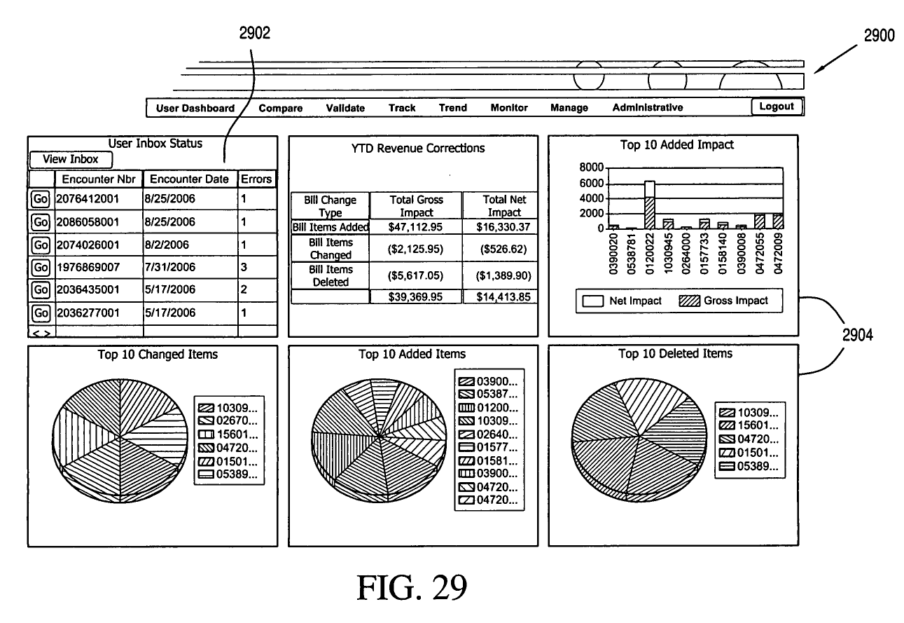

Referring to FIG. 29, upon logging on, a user main display or dashboard 2900 may be presented to the user, including fields selected according to the user's role and permissions.

These fields may include a user inbox 2902 which includes a list of invoices, patient encounters, or other work items assigned to or monitored by the user, as well as one or more reporting items 2904, providing a summary report of system data relevant to the user's role and permissions.

It will be understood that the above-described embodiments of the invention are illustrative in nature, and that modifications thereof may occur to those skilled in the art. Accordingly, this invention is not to be regarded as limited to the embodiments disclosed herein, but is to be limited only as defined in the appended claims.

I claim:

1. A computer method for identifying charge capture opportunities, comprising:
a receiving and storing step wherein at least one itemized bill and at least one final bill are received and stored by a server computer;
a comparing step wherein said final bill and said itemized bill are compared to identify discrepancies between line items of said itemized bill and line items of said final bill;
at least one evaluating step wherein a selected bill is evaluated according to a set of rules to identify potential missing charges associated with line items of said selected bill;
a reporting step wherein reporting data summarizing said discrepancies and said missing charges is generated by said server computer and forwarded to a client computer for display to a user.

2. The method according to claim 1, wherein said comparing step further comprises:
performing a forward comparison verifying that, for each line item on the itemized bill, a corresponding and correct line item is found on the final bill; and
performing a backward comparison verifying that, for each line item on the final bill, at least one corresponding and correct line item is found on the itemized bill.

3. The method according to claim 2, wherein line items of the itemized bill may have a one-to-one or an n-to-one relationship to line items on the final bill.

4. The method according to claim 1, wherein said evaluating step comprises:
selecting a line item in said selected bill and identifying a rule from said set of rules that is applicable to the selected line item;
a searching step wherein said selected bill is searched for at least one line item corresponding to said selected line item according to said applicable rule; and
if no corresponding line item is found in said selected bill, identifying at least one potential missing charge related to said selected line item according to said applicable rule.

5. The method according to claim 4, wherein said set of rules comprises a plurality of rules each defined by a primary code and at least one associated code.

6. The method according to claim 5, wherein said applicable rule is identified by finding in said set of rules a rule having a primary code that matches a charge code of said selected line item.

7. The method according to claim 5, wherein said searching step comprises:
for each associated code in said applicable rule, comparing said associated code to a charge code of each line item of said selected bill;
for each associated code in said applicable rule for which a line item having a matching charge code is not found, identifying a potential missing charge.

8. The method according to claim 5, wherein, for each rule, said at least one associated code is assigned to one of a plurality of code sets, wherein each code set indicates a different category of associated codes.

9. The method according to claim 8, wherein said different categories are defined according to different code types.

10. The method according to claim 8, wherein said different categories are defined according to different probabilities of an association between the primary code and the associated codes within the code set.

11. The method according to claim 10, wherein said reporting data includes a probability of said potential missing charge being an actual missing charge based on said probability indicated by the code set containing the associated code.

12. The method according to claim 6, wherein if no applicable rule is found a user notification message is generated.

13. The method according to claim 1, further comprising a charge verification step wherein charges associated with line items of at least one of the itemized bill and the final bill are verified against a charge description master file.

14. The method according to claim 4, wherein said selected bill is an itemized bill.

15. The method according to claim 4, wherein said selected bill is a final bill.

16. The method according to claim 1, wherein prior to said comparing step, a single itemized bill and a single corresponding bill are selected for comparison from said at least one itemized bill and said at least one final bill.

17. A computer-implemented system for identifying charge capture opportunities, comprising:
a server computer;
a communication interface in communication with said server computer adapted for communication with at least one client computer via a network;
a database accessible by said server computer;
a storage device readable by said server computer, the storage device having stored thereon a computer program comprising computer readable code executable by said server computer to perform a method for identifying charge capture opportunities, the method comprising:
a receiving and storing step wherein at least one itemized bill and at least one final bill are received by said server computer and stored;
a comparing step wherein said final bill and said itemized bill are compared to identify discrepancies between line items of said itemized bill and line items of said final bill;
at least one evaluating step wherein a selected bill is evaluated according to a set of rules to identify potential missing charges associated with line items of said selected bill;
a reporting step wherein reporting data summarizing said discrepancies and said missing charges is generated by said server computer and forwarded to a client computer for display to a user.

18. A computer program product comprising:
at least one computer readable storage device having computer readable code embodied thereon, said computer readable code for programming one or more computers to perform a method for identifying charge capture opportunities, the method comprising:
a receiving and storing step wherein at least one itemized bill and at least one final bill are received and stored by a server computer;
a comparing step wherein said final bill and said itemized bill are compared to identify discrepancies between line items of said itemized bill and line items of said final bill;
at least one evaluating step wherein a selected bill is evaluated according to a set of rules to identify potential missing charges associated with line items of said selected bill;
a reporting step wherein reporting data summarizing said discrepancies and said missing charges is generated by said server computer and forwarded to a client computer for display to a user.
